(19) United States
(12) Patent Application Publication
(10) Pub. No.: US 2024/0098826 A1
(43) Pub. Date: Mar. 21, 2024

(54) EARLY BEAM FAILURE RECOVERY FOR REDUCED OUTAGE

(71) Applicant: Nokia Technologies Oy, Espoo (FI)

(72) Inventors: Ahmad AWADA, Munich (DE); Halit Murat GÜRSU, Munich (DE); Timo KOSKELA, Oulu (FI)

(21) Appl. No.: 18/264,350

(22) PCT Filed: Mar. 23, 2021
(86) PCT No.: PCT/EP2021/057430

§ 371 Date: Aug. 4, 2023

(51) Int. Cl. H04W 76/19

(52) U.S. Cl. CPC H04W 76/19

(57) ABSTRACT

Various example embodiments relate to methods, devices and systems that support early beam failure recovery. A terminal device may terminal device may comprise at least one processor and at least one memory including computer program code. The at least one memory and the computer program code may be configured to, with the at least one processor, cause the terminal device to perform actions including detecting a beam failure state in association with at least one serving beam, and determining if at least one non-serving beam better than the at least one serving beam is available. The actions may further include triggering an early beam failure recovery (BFR) procedure in a case where the beam failure state is detected and the at least one non-serving beam better than the at least one serving beam is available.

### TECHNICAL FIELD

Various example embodiments described herein generally relate to communication technologies, and more particularly, to methods, devices and systems that support early beam failure recovery.

### BACKGROUND

Certain abbreviations that may be found in the description and/or in the figures are herewith defined as follows:
BFD Beam Failure Detection
BFI Beam Failure Instance
BFR Beam Failure Recovery
BLER Block Error Rate
CE Control Element
CFRA Contention Free Random Access
C-RNTI Cell Radio Network Temporary Identifier
CSI-RS Channel State Information Reference Signal
DCI Downlink Control Information
gNB next Generation Node-B
MAC Medium Access Control
OOS Out of Synchronization
PDCCH Physical Downlink Control Channel
PDSCH Physical Downlink Shared Channel
PHY Physical
PUCCH Physical Uplink Control Channel
QCL Quasi co-Located
RACH Random Access Channel
RRC Radio Resource Control
RSRP Reference Signal Received Power
RSRQ Reference Signal Received Quality
SINR Signal to Interference and Noise Ratio
SSB Synchronization Signal Block
TCI Transmission Configuration Indicator

Beamforming is an integral part of 5G New Radio (NR). As 5G NR is deployed in higher frequencies such as millimeter wave (mmWave) bands that have severe atmospheric absorption and path loss, highly-directional radio beams are needed to ensure coverage and improve spectrum efficiency.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, an example embodiment of a terminal device is provided. The terminal device may comprise at least one processor and at least one memory including computer program code. The at least one memory and the computer program code may be configured to, with the at least one processor, cause the terminal device to perform actions including detecting a beam failure state in association with at least one serving beam, and determining if at least one non-serving beam better than the at least one serving beam is available. The actions may further include triggering an early beam failure recovery procedure in a case where the beam failure state is detected and the at least one non-serving beam better than the at least one serving beam is available.

In a second aspect, an example embodiment of a network device is provided. The network device may comprise at least one processor and at least one memory including computer program code. The at least one memory and the computer program code may be configured to, with the at least one processor, cause the network device to perform actions including receiving a capability report from a terminal device. The capability report may include an indicator indicating that the terminal device can support an early beam failure recovery procedure. The actions may further include sending configuration for the early BFR procedure to the terminal device.

In a third aspect, an example embodiment of a method implemented at a terminal device is provided. The method may comprise detecting a beam failure state in association with at least one serving beam, and determining if at least one non-serving beam better than the at least one serving beam is available. In a case where the beam failure state is detected and the at least one non-serving beam better than the at least one serving beam is available, the method may further comprise triggering an early beam failure recovery procedure.

In a fourth aspect, an example embodiment of a method implemented at a network device is provided. The method may comprise receiving a capability report from a terminal device. The capability report may include an indicator indicating that the terminal device can support an early beam failure recovery procedure. The method may further comprise sending configuration for the early beam failure recovery procedure to the terminal device.

In a fifth aspect, an example embodiment of an apparatus implemented at a terminal device for early beam failure recovery is provided. The apparatus may comprise means for detecting a beam failure state in association with at least one serving beam, means for determining if at least one non-serving beam better than the at least one serving beam is available, and means for triggering an early beam failure recovery procedure in a case where the beam failure state is detected and the at least one non-serving beam better than the at least one serving beam is available.

In a sixth aspect, an example embodiment of an apparatus implemented at a network device for early beam failure recovery is provided. The apparatus may comprise means for receiving a capability report from a terminal device, the capability report including an indicator indicating that the terminal device supports an early beam failure recovery procedure, and means for sending configuration for the early beam failure recovery procedure to the terminal device.

In a seventh aspect, an example embodiment of a computer program product is provided. The computer program product may be embodied in at least one computer readable medium and comprise instructions, when executed by at least one processor of a terminal device, causing the terminal device to carry out a method according to the aforementioned third aspect.

In an eighth aspect, an example embodiment of a computer program product is provided. The computer program product may be embodied in at least one computer readable medium and comprise instructions, when executed by at least one processor of a network device, causing the network device to carry out a method according to the aforementioned fourth aspect.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 is a schematic diagram illustrating an example cellular communication system in which embodiments of the present application can be implemented.

FIG. 2 is a communication flow diagram illustrating a method for triggering early beam failure recovery in a cellular communication system according to an example embodiment.

FIG. 3 is a communication flow diagram illustrating a method for triggering early beam failure recovery in a cellular communication system according to an example embodiment.

FIG. 4 is a communication flow diagram illustrating a method for providing early beam failure recovery configuration to a user equipment device according to an example embodiment.

FIG. 5 is a communication flow diagram illustrating an early beam failure recovery procedure according to an example embodiment.

FIG. 6 is a communication flow diagram illustrating an early beam failure recovery procedure according to an example embodiment.

FIG. 7 illustrates a block diagram of a communication system in which example embodiments of the present disclosure can be implemented.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

As used herein, the term “network device” refers to any suitable entities or devices that can provide cells or coverage, through which the terminal device can access the network or receive services. The network device may be commonly referred to as a base station. The term “base station” used herein can represent a node B (NodeB or NB), an evolved node B (eNodeB or eNB), or a gNB or an ng-eNB. The base station may be embodied as a macro base station, a relay node, or a low power node such as a pico base station or a femto base station. The base station may consist of several distributed network units, such as a central unit (CU), one or more distributed units (DUs), one or more remote radio heads (RRHs) or remote radio units (RRUs). The number and functions of these distributed units depend on the selected split RAN architecture.

As used herein, the term “terminal device” or “user equipment” (UE) refers to any entities or devices that can wirelessly communicate with the network devices or with each other. Examples of the terminal device can include a mobile phone, a mobile terminal (MT), a mobile station (MS), a subscriber station (SS), a portable subscriber station (PSS), an access terminal (AT), a computer, a wearable device, an on-vehicle communication device, a machine type communication (MTC) device, a D2D communication device, a V2X communication device, a sensor and the like. The term “terminal device” can be used interchangeably with a UE, a user terminal, a mobile terminal, a mobile station, or a wireless device.

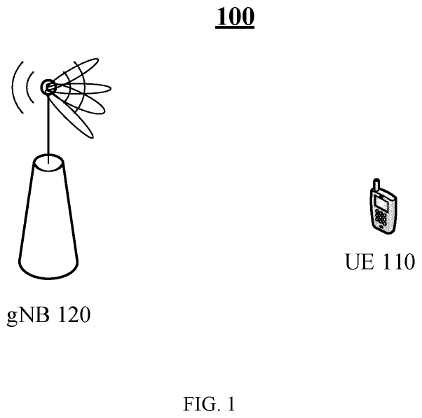

FIG. 1 illustrates a schematic diagram of a cellular communication system 100 in which example embodiments of the present disclosure can be implemented. Referring to FIG. 1, the cellular communication system 100, which may be a part of a communication network, may include a base station 120 shown as gNB and a user equipment (UE) device 110 in communication with the gNB 120. The gNB 120 may serve one or more cells (not shown), and the UE 110 may connect to one or more of the cells served by the gNB 120. For example, up to 5 cells may aggregate on the UE 110 by carrier aggregation (CA). In dual connectivity, the UE 110 may connect to two base stations including the gNB 120. The gNB 120 may act as a master node (MN) that operates a master cell group (MCG) serving the UE 110, or as a secondary node (SN) that operates a secondary cell group (SCG) serving the UE 110. The cells serving the UE 110, either in the MCG or in the SCG, may be referred to as serving cells. Hereinafter, the reference numeral “120” may denote the gNB or a serving cell of the gNB that the UE 110 is connected to. The serving cell 120 may communicate with the UE 110 on one or more beams configured/activated for the UE 110. For example, the UE 110 can be configured and served with up to 8 active beams for physical downlink shared channel (PDSCH) reception and up to 3 beams for physical downlink control channel (PDCCH) reception. As a common implementation, the serving cell may configure the UE 110 with one active beam for both PDCCH and PDSCH reception.

Beam based operations require that the active beams for UE are known for the serving cell and the UE at the same time, which can be achieved via beam management. Beam management may be understood as a set of layer 1 (L1) and layer 2 (L2) procedures used to acquire and maintain the beams for the UE for transmission of control and data channels. For example, UE can be configured to periodically measure and report to the serving cell up to N highest quality beams (e.g., in terms of RSRP, RSRQ and/or SINR). If the serving cell decides that an active beam for PDCCH reception needs to be replaced with one of the reported beams, the serving cell sends a beam switching command, e.g., a new transmission configuration indicator (TCI) state indication for PDCCH MAC CE to the UE. Then the UE may replace the serving beam with the new beam by activating the new TCI state. The PDSCH beam may be switched by DCI information transmitted on PDCCH. A TCI State may indicate to the UE the reception assumption for PDCCH or PDSCH. As an example the TCI State may include information on one or more DL RS and the QCL type associated with the respective DL RS. When a TCI state is activated e.g. for PDCCH reception, UE can assume that the PDCCH DM-RS are quasi co-located with one or more of the DL RS. Quasi co-location assumption may be e.g. spatial RX (sometimes referred as qcl-typeD) which indicates to UE that it can assume same RX spatial filter/beam for PDCCH reception as for the DL RS indicated by the TCI State. In similar manner the TCI state may be activated for PDSCH reception and UE may assume the PDSCH DM-RS to be QCL′d with one or more DL RS indicated by the TCI state.

In 3GPP, a beam failure recovery (BFR) procedure has been specified to detect and recover one or multiple serving beams for PDCCH reception in a failure condition. The BFR procedure may generally comprise following aspects.

Beam Failure Detection Reference Signal (BFD-RS)

The network may configure UE with a set of reference signals for monitoring quality of radio links/beams. This set may be referred to as q0 or beam failure detection reference signal (BFD-RS). Typically, BFD-RS(s) are configured to be spatially quasi co-located (QCL'd) with PDCCH demodulation reference signal (DMRS) ports, i.e., these reference signals correspond to downlink beams used to transmit PDCCH to the UE. The downlink beams may be identified by a reference signal, either SS/PBCH block (SSB) index (time location index) or CSI-RS resource index, thus the BFD-RS (or set of q0) is a list of SS/PBCH block and/or CSI-RS resources. The network may explicitly configure the BFD-RS list using RRC signaling or with combined RRC and MAC CE signaling where MAC CE can be used to activate a set or subset of RRC configured resources as BFD-RS.

When UE is not explicitly configured with a BFD-RS list, it may determine BFD-RS resources implicitly based on the configured/indicated/activated PDCCH-TCI states per CORESET, i.e., the downlink reference signals (CSI-RS, SS/PBCH block) that are spatially QCL'd with PDCCH DMRS ports, or in other words, PDCCH beams.

Beam Failure Detection (BFD)

The PHY layer may assess quality of a radio link/beam based on BFD-RS in the beam failure detection set (q0 set) periodically. The assessment is done per BFD-RS. When the radio link condition of each BFD-RS in the q0 set is considered to be in a failure condition, i.e., the hypothetical PDCCH BLER estimated using the BFD-RS is above a configured threshold, a beam failure instance (BFI) indication is provided to a higher layer (e.g., the MAC layer). An example of the BLER threshold value may be the out of synchronization (OOS) threshold used for radio link monitoring OOS/Qout=10%. The quality evaluation and BFI indication may be done periodically. If at least one BFD-RS is not in the failure condition, no BFI indication is provided to the higher layer.

The MAC layer may implement a counter to count the BFI indications from the PHY layer. When the BFI counter reaches a maximum value Q, beam failure is detected/declared. The maximum value Q may be configured by the network to be for example 1, 2, 4, 5, 6, 8 or 10. The BFI counter can be configured to be supervised by a timer, which is started/restarted each time the MAC layer receives a BFI indication from the PHY layer. Once the timer expires, the BFI counter is reset (counter value is set to zero). Alternatively or additionally, a timer may also be configured to supervise the beam failure recovery procedure. The timer may be started upon detecting beam failure, and when the timer expires, the UE declares the beam failure recovery to be unsuccessful. While the timer is running, the UE may try to recover the failed beam/link.

Beam Failure Recovery (BFR) Procedure

Once beam failure has been declared, the UE initiates beam failure recovery by selecting and indicating a new candidate beam for PDCCH reception to the network. The UE may determine a new candidate beam based on e.g. L1-RSRP measurements and perform either a contention-free random access (CFRA) or contention-based random access (CBRA) procedure to indicate the candidate beam to the serving cell. The network can configure the UE with candidate beam specific CFRA preambles, i.e., the candidate beam (SSB or CSI-RS) can be indicated using dedicated signal (CFRA preamble). A specific threshold may be configured so that if any of the new candidate beams (also referred to as q1 set) are, based on e.g. L1-RSRP measurements, above the threshold, the UE selects a candidate beam from the new candidate beams above the threshold and performs CFRA. In case there are no CFRA candidate beams above the configured threshold, the UE may select any other beam as the new candidate so long as the cell is suitable, and utilize contention based signaling to indicate the new candidate, i.e., CBRA preamble resources are mapped to specific downlink RS (SSB).

As mentioned above, the beam management relies on the UE periodic reporting of N strongest beam measurements and on the UE reception of a beam switching command MAC CE. The serving cell may trigger a beam switch when a neighboring/non-serving beam is better than the serving beam. For instance, the serving cell may make a beam switching decision if a condition L1n>L1s+Off is met where L1n and L1s denote L1-RSRP, L1-RSRQ or L1-SINR of the neighboring/non-serving beam and the serving beam in the same serving cell, respectively, and Off denotes an offset/margin. In a second example, the serving cell may trigger a beam switch if the condition L1n>L1s+Off is satisfied for TTT where TTT refers to time to trigger. In a third example, the serving cell may trigger a beam switch if a condition L2n>L2s+Off is satisfied for TTT where L2n and L2s denote a L2-filtered value of L1-RSRP, L1-RSRQ or L1-SINR of the neighboring/non-serving beam and the serving beam in the same serving cell, respectively. The L2 filtering may be applied by the serving cell.

The beam switching may not be triggered on time either because of failure in sending the periodic measurement report (the serving cell may not receive the measurement report on a physical uplink control channel (PUCCH) or a physical uplink shared channel (PUSCH)) or failure in receiving the beam switching command MAC CE (the UE may fail to receive the MAC CE). The causes of the failure may be linked to delay in L1 measurements caused by L1 filtering, measurement errors, or delay in the beam switching decision if some measurement related offsets/TTTs or additional L2 filtering are applied at the serving cell to make a decision on beam switching.

In case at least one BFI is detected and there is another suitable (e.g. better in terms of quality such as RSRP/RSRQ/SINR) beam in the serving cell but the beam switching was not triggered on time, the UE may likely not receive a beam switching command MAC CE from the serving cell because the serving beams may be in failure now. In other words, the UE is expected to have received the beam switching command MAC CE before the radio link between the UE and the serving cell becomes failed. As the beam failure recovery is triggered when beam failure is declared, the UE has to wait for a period of time until the number of detected BFIs reaches the configured maximum value Q. This would result in unnecessary waiting for initiating beam failure recovery and long outage of services, which is unacceptable especially for services requiring high reliability.

One option to reduce the waiting time is to configure the maximum value Q for the BFI counter with a small number e.g. one. In such a case, however, the UE would trigger beam failure recovery once one BFI is detected, even if the serving beam is the best to serve the UE. The UE may be instructed by the network to switch back to the current serving beam immediately after triggering the beam failure recovery. It would cause high signalling overhead and frequent interruption for the UE.

To reduce the above mentioned waiting time and outage of services, a solution to trigger early beam failure recovery is proposed. As discussed above, a normal beam failure recovery is triggered when BFI (i.e., all serving beams being in failure) is detected for a maximum number of times. In example embodiments, the early beam failure recovery may be triggered when at least one beam is in failure and a non-serving beam better than the failed serving beam is available for the UE. Thus the UE does not need to wait for the maximum number of BFIs being detected. In some embodiments, the UE may set a timer when aforementioned conditions to trigger the early beam failure recovery are satisfied. If the UE does not receive a command or trigger a procedure to reconfigure/remove/switch the serving beam/cell during the timer is running, the UE can trigger the early beam failure recover when the timer expires. Hereinafter, various example embodiments of methods, devices and systems for trigging the early beam failure recovery will be described with reference to the drawings.

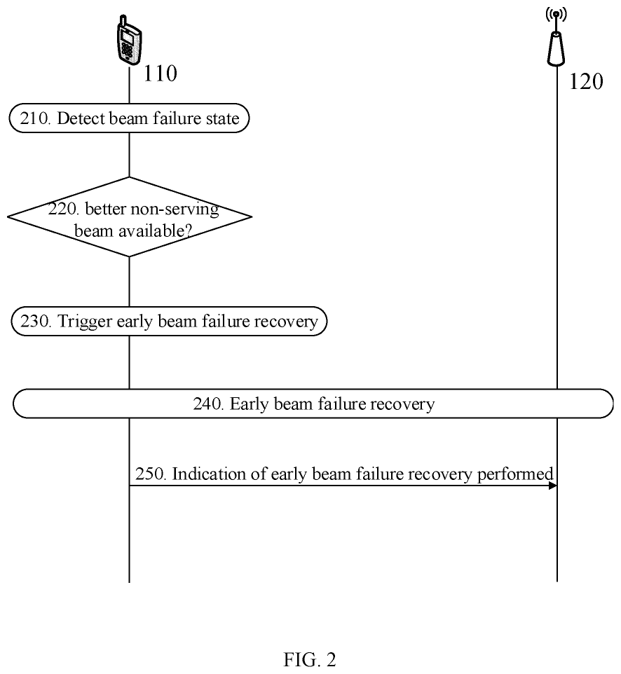

FIG. 2 is a communication flow diagram illustrating a method for triggering early beam failure recovery in a cellular communication system according to an example embodiment. The method of FIG. 2 may be implemented by a user equipment device and a base station, such as the UE 110 and the gNB 120 described above with respect to FIG. 1.

In 210, the UE 110 may detect a beam failure state in association with at least one serving beam. Detecting beam failure may be based on the UE 110 monitoring a beam failure detection reference signal (BFD-RS) in the beam failure detection set (i.e., the q0 set) associated with the serving beam. The serving beam is configured/activated for the UE 110 to receive a downlink control channel e.g. PDCCH. In some embodiments, if at least one BFD-RS in the q0 set has quality lower than a threshold, the UE 110 may determine that the serving beam associated with the BFD-RS is in the beam failure state. For example, the UE 110 may perform measurements to determine a reference signal received power (RSRP), reference signal received quality (RSRQ), signal to interference and noise ratio (SINR) and/or hypothetical PDCCH BLER value of the serving beam using the BFD-RS. If the measurement value is worse than a configured threshold, the UE 110 may determine that beam failure has occurred for the serving beam. In some embodiments, if the at least one BFD-RS that has quality worse than the configured threshold corresponds (e.g. BFD-RS/DL-RS is configured as spatial relation RS for the uplink or UE transmits on uplink based on the reception assumptions of the BFD-RS/DL-RS) to a serving beam carrying an uplink control channel (e.g., PUCCH), the UE 110 determines that beam failure is detected. In some embodiments, if a number Y of beam failure instances (BFIs) are detected, the UE 110 determines that beam failure has occurred. As mentioned above, the BFI is indicated when all BFD-RSs in the q0 set have quality worse than the configured threshold. Here the number Y of BFIs to decide on beam failure is larger than or equal to one but substantially smaller than the above mentioned maximum number Q for the BFI counter to trigger the normal BFR procedure. For example, the number Y may be set to one.

In 220, the UE 110 may determine if there is at least one non-serving beam better than the at least one serving beam that is in the beam failure state. For example, as discussed above with respect to 210, the UE 110 may monitor RSs associated with the non-serving beams configured for the UE 110 and determine L1-RSRP, L1-RSRQ, L1-SINR and/or hypothetical PDCCH BLER values of the non-serving beams. The UE 110 may compare the L1 measurements or their L2 filtered values of the non-serving beams with those of the serving beam. Here, L2 filtering may be configured by network and examples thereof may include averaging a number of L1 samples, scaling up/down L1 measurements by a coefficient, or increasing/decreasing L1 measurements by a constant. If the L1 measurement(s) or its L2 filtered value of a non-serving beam is better than that of the serving beam by a certain offset Off for time to trigger TTT, the UE 110 determines that the non-serving beam is better than the serving beam. Here the offset Off and the time period TTT may be larger than or equal to zero and they both may also be configured by the network.

As previously mentioned, UE may periodically measure and report to the serving cell up to N highest quality beams (e.g. in terms of RSRP). In some embodiments, if the beam measurement report includes one or more non-serving beams that have quality better than the serving beam, the UE 110 may determine at 220 that at least one non-serving beam better than the serving beam is available. In some embodiments, if the beam measurement report includes a non-serving beam as the highest quality beam, the UE 110 may also determine at 220 that at least one non-serving beam better than the serving beam is available.

In 230, the UE 110 may trigger an early BFR procedure if the beam failure state is detected in 210 and at least one non-serving beam better than the serving beam in the failure state is determined in 220. Compared with a normal BFR procedure that is triggered when a maximum number Q of BFIs are detected, the early BFR procedure occurs much earlier because it may be triggered when a subset (at least one) of serving beams is in failure or a less number Y (Y<Q, e.g., Y=1) of BFIs are detected. The UE 110 does not need to wait for a time period until the maximum number Q of BFIs are detected to trigger the normal BFR procedure. Therefore, the example embodiment can reduce unnecessary waiting time and avoid long outage of services.

Then in 240, the early BFR procedure may be implemented by the UE 110 and the gNB 120 in cooperation with each other. The early BFR procedure may be substantially similar to the normal BFR procedure and will be discussed in detail later. Here, it would be appreciated that although the operation 230 of triggering the early BFR procedure is illustrated as a separate operation from the early BFR procedure 240, the operation 230 may be a part of the early BFR procedure 240. For example, the UE 110 may trigger the early BFR procedure by selecting and indicating to the gNB 120 a new candidate beam for PDCCH reception.

From network perspective, the gNB 120 may not be able to know if the BFR procedure implemented at 240 is an early BFR procedure or a normal BFR procedure. In some embodiments, the UE 110 may further send the gNB 120 an indication indicating that the early BFR procedure is triggered/performed in 250. The indication may be provided to the gNB during or after the early BFR procedure and it will be discussed in detail later.

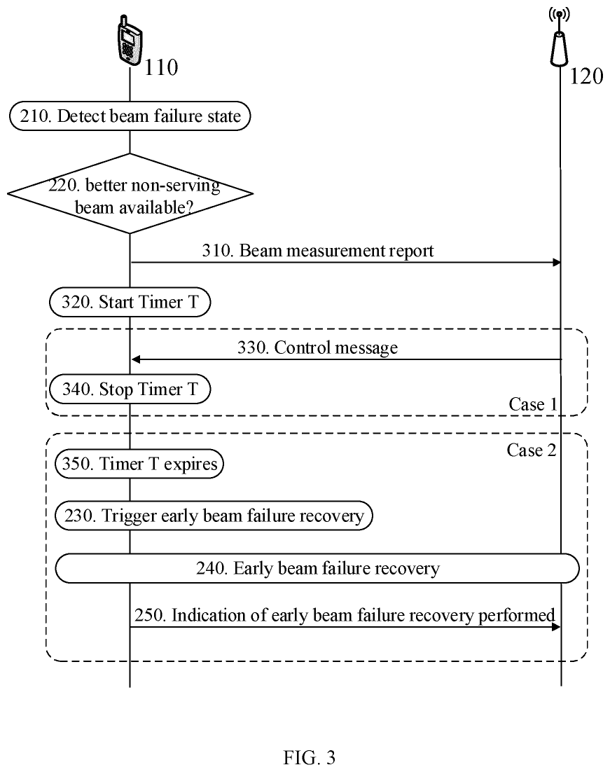

FIG. 3 is a communication flow diagram illustrating a method for triggering early beam failure recovery in a cellular communication system according to an example embodiment. In the method of FIG. 3, operations the same as or similar to those illustrated in FIG. 2 are assigned with the same or similar reference numerals and a repetitive description thereof would be omitted here. Hereinafter description will focus on difference between the method of FIG. 3 and the method of FIG. 2.

Referring to FIG. 3, the UE 110 may start a timer T in 320 before it triggers the early BFR procedure in 230, if the beam failure state is detected in 210 and at least one non-serving beam better than the serving beam in the failure state is determined in 220. The timer T may have a duration Z configured by network. In some embodiments, the timer duration Z may be less than a time period for detecting the maximum number Q of BFIs, or less than a time period for detecting a number (Q-Y) of BFIs, to ensure that the early BFR procedure is triggered before the normal BFR procedure. Here the number (Q-Y) refers to a difference between the maximum number Q for triggering the normal BFR procedure and the number Y for triggering the early BFR procedure.

In some embodiments, if the UE 110 determines the at least one non-serving beam is better than the serving beam in 220 before it detects beam failure associated with the serving beam in 210, the UE 110 may start the timer T as soon as it detects the beam failure state in 210. In some embodiments, if the UE 110 detects the beam failure state in 210 before it determines the at least one non-serving beam is better than the serving beam in 220, the UE 110 may start the timer T when the UE 110 sends a beam measurement report including the non-serving beam in 310 after it determines the at least one non-serving beam is better than the serving beam in 220. For example, the timer T may be started after an uplink slot for transmitting the beam measurement report including the determined non-serving beam.

In any of the embodiments herein, the serving beam(s) may refer to beam(s) (that may be identified by DL-RS) that correspond/are used for PDCCH transmission for UE or PDCCH reception by UE. Alternatively or additionally, the serving beam(s) may refer to/correspond to/are used for PDSCH transmission for UE or PDSCH reception by UE. In a further alternative the serving beam(s) may refer to the DL-RS that are configured as reference/spatial relation for any uplink transmission (PUCCH/PUSCH) performed by UE.

In a first case, the UE 110 may stop the timer T at 340 in response to a control message received from the gNB 120 at 330. In some embodiments, the control message received at 330 may be a beam switching command e.g. a TCI state indication for PDCCH MAC CE received from the gNB 120. The TCI state indication for PDCCH may comprise a serving cell ID, a TCI state ID and a control resource set (CORESET) ID. For example, if one or more serving beams for PDCCH reception, which are indicated by active TCI states for respective CORESETs, become failed and the UE 110 receives a new or same TCI state indication for a CORESET that corresponds to at least one of the one or more failed serving beams, the UE 110 would stop the timer T and perform the beam switching procedure. On the contrary, if the UE 110 receives a new TCI state indication for a CORESET that does not correspond to any one of the one or more failed serving beams for PDCCH, the UE 110 would not stop the timer T.

In some embodiments, the timer T may be configured per CORESET. For example, if two serving beams for PDCCH reception indicated by two TCI state indications for two CORESETs S1, S2 become failed, the UE 110 would start two timers T1, T2 for the CORESETs S1, S2, respectively. When the UE 110 receives a new or same TCI state indication for the CORESET S1, the UE 110 would stop the timer T1 but the timer T2 for the CORESET S2 would not be affected. Then, the UE 110 would perform the beam switching procedure for the serving beam associated with the CORESET S1.

In some embodiments, the control message received at 330 may be a cell change command e.g. a handover command received from the gNB 120. If the gNB 120 instructs the UE 110 to perform handover from the (source) serving cell to a target cell, the UE 110 would stop the timer T because it does not need to recover the serving beam on the current serving cell.

In some embodiments, the UE 110 may stop the timer T at 340 in response to an RRC level measurement reporting triggered by e.g. event A3 at the UE 110 in 330. The event A3 is triggered when the UE 110 determines that a neighboring cell is better than a special cell, i.e., a primary cell (PCell) in a master cell group or a primary secondary cell (PSCell) in a secondary cell group, and the event A3 would lead to handover from the current special cell to the neighboring cell. If the event A3 is triggered, and the serving cell is the special cell as a source in the subsequent handover procedure or a secondary cell (SCell) under the control of the special cell that would be removed during handover of the special cell, the UE 110 does not need to recover the serving beam on the serving cell. Then the UE 110 would stop the timer T.

In a second case, if the UE 110 does not receive the beam switching command or the cell change command or trigger the RRC level measurement reporting using e.g. event A3, the timer T would expire at 350 and the UE 110 may trigger the early BFR procedure at 230 as previous noted. By configuring the time T with a proper duration Z e.g. less than a time period for detecting the maximum number Q of BFIs to trigger the normal BFR recovery or less than a time period for detecting a number (Q-Y) of BFIs, it would ensure that the early BFR procedure is triggered before the normal BFR procedure.

In one example, any of the proposed methods herein can be performed by UE or UE can be configured to perform per serving cell or on serving cell basis. As an example, UE may be configured to perform early BFR procedure for a primary cell (PCell) but not any of secondary cells (SCells). Alternatively, UE may be configured to perform early BFR procedure for one or more serving cells that have been configured for beam failure detection. The serving cell herein may refer to PCell or SCell.

FIG. 4 is a communication flow diagram illustrating a method for providing BFR configuration to a user equipment device according to an example embodiment. The method of FIG. 4 may be implemented before and considered as a part of the methods shown in FIGS. 2-3.

Referring to FIG. 4, at 410, the UE 110 may report its capability to the gNB 120. In some embodiments, the UE 110 may actively send a capability report to the gNB 120 e.g. during initial attachment to the network or in a tracking area updating procedure. In some embodiments, the UE 110 may send the capability report to the gNB 120 in response to a capability enquiry received from the gNB 120. The capability report may include an indication indicating that the UE 110 can support the early BFR procedure.

In 420, the gNB 120 may provide configuration for the early BFR procedure to the UE 110, responsive to the capability report indicating that the UE 110 supports the early BFR procedure. In some embodiments, the configuration for the early BFR procedure may comprise parameters for triggering or implementing the early BFR procedure, for example the number Y of BFIs to trigger the early BFR procedure, the offset Off, time to trigger TTT and one or more filtering parameters for measuring and comparing the serving beam with one or more non-serving beams, and a time duration Z for the timer T, as previously mentioned. Then the configuration for the early BFR procedure may be applied at the UE 110.

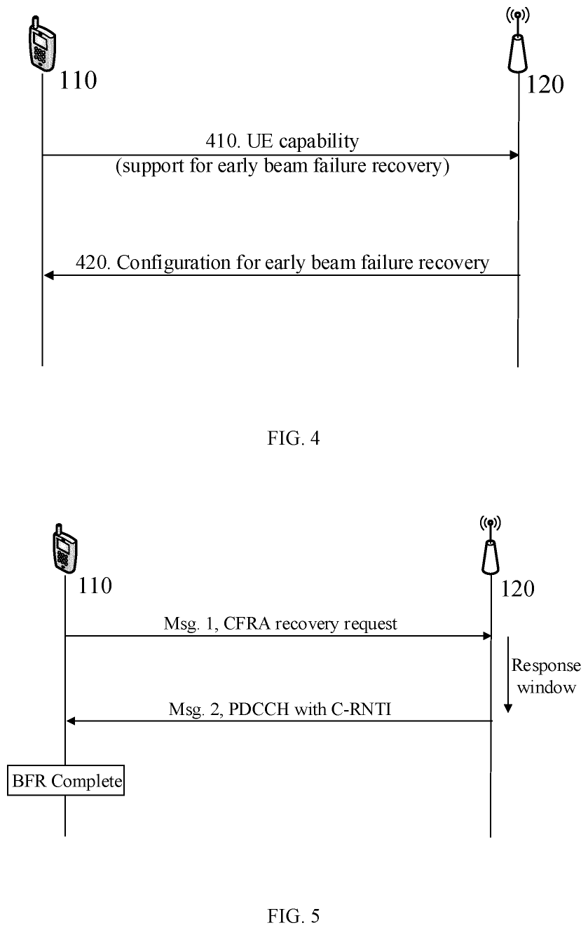

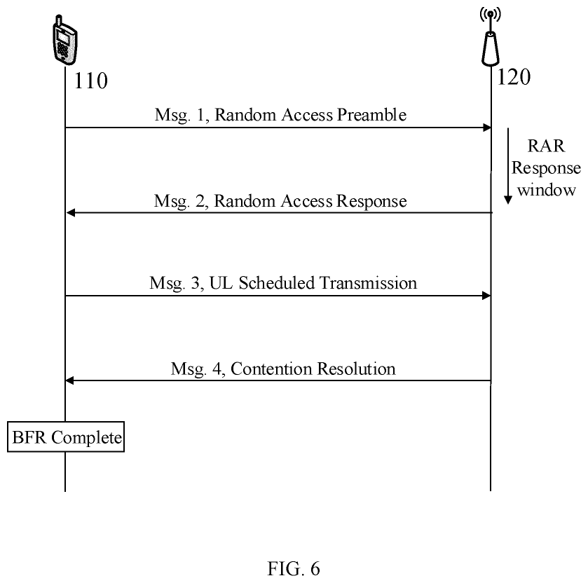

The early BFR procedure implemented at 240 in FIGS. 2-3 may be substantially the same as or similar to the normal BFR procedure and it may re-use the random access channel (RACH) procedure, such as the contention free random access (CFRA) procedure and the contention based random access (CBRA) procedure. The gNB 120 may provide the UE 110 with a list of candidate beams (also referred to as q1 set) associated with dedicated CFRA preambles. The candidate beams which can be used for CFRA-based BFR can be SS/PBCH block and/or CSI-RS signals. If the new candidate beam better than the current serving beam determined at 220 in FIGS. 2-3 is selected from the CFRA candidate beam list, the UE 110 may trigger a CFRA-based BFR procedure. Otherwise, the UE 110 may trigger a CBRA-based BFR procedure. FIG. 5 is a communication flow diagram illustrating a CFRA-based BFR procedure according to an example embodiment, and FIG. 6 is a communication flow diagram illustrating a CBRA-based BFR procedure according to an example embodiment. It would be appreciated that the procedures shown in FIGS. 5-6 both can be implemented at 240 in FIGS. 2-3.

Referring to FIG. 5, at Message (Msg.) 1, the UE 110 may send the gNB 120 a beam failure recovery request by use of a dedicated preamble. The dedicated preamble indicates the beam failure recovery and a new candidate beam, and it also identifies the UE 110 to the gNB 120.

In response to the beam failure recovery request received in Msg. 1, the gNB 120 may respond on PDCCH scrambled with C-RNTI as Msg. 2. When the UE 110 has successfully received the response scrambled with its C-RNTI, it considers the BFR procedure to be successful. Then the UE 110 continues to monitor PDCCH and PDSCH using the QCL assumption of the indicated candidate beam, until a new TCI State for PDCCH indicating a new beam for PDCCH is indicated (activated/reconfigured). In some embodiments, the gNB 120 may include the new TCI State for PDCCH in Msg. 2. For the transmission of the uplink control channel, the same spatial filter as was used for indicating the new candidate beam may be used by the UE 110 until reconfigured by the gNB 120.

In some embodiments, the early BFR procedure may be triggered for a subset of PDCCH beams. Then in subsequent communication, the UE 110 may further indicate the failed beams to the gNB 120. Responsive to the indication of the failed beams, the gNB 120 may re-configure/activate new beams for the UE 110 to replace the failed beams.

As the early BFR procedure may be substantially the same as or similar to the normal BFR procedure, the gNB 120 may not be able to distinguish them from each other. In some embodiments, the UE 110 may indicate to the gNB 120 that the early BFR procedure is performed during or after the random access/early BFR procedure.

FIG. 6 illustrates the CBRA-based BFR procedure according to an example embodiment. The CBRA-based BFR may work as a fall-back mechanism if the CFRA-based BFR is not possible, i.e., when the measurements of the RSs associated with CFRA resources are below a certain threshold that is configured by the network. Also, the CBRA-based BFR may be used by default when the CFRA recovery is not configured.

Referring to FIG. 6, at Msg. 1, the UE 110 may indicate a new candidate beam to the gNB 120 by transmitting a corresponding preamble, i.e., the CBRA preamble resources are mapped to a specific downlink RS i.e. SS/PBCH block.

At Msg. 2, the UE 110 expects a random access response (RAR) from the gNB 120 within an RAR response window, as normally in the RACH procedure. The RAR response may include an uplink grant for transmission of Msg. 3.

Msg. 3 may be transmitted using resources scheduled by the RAR response and it may include a C-RNTI MAC CE. In some embodiments where, for example, the early BFR procedure is triggered for a subset of serving beams instead of all serving beams being in failure, the UE 110 may also include indication of the failed serving beams in Msg. 3 so that the gNB 120 may perform reconfiguration of the serving beams for the UE 110 in a more timely manner. In some embodiments, the UE 110 may indicate the failed beams to the gNB 120 in subsequent communication.

At Msg. 4, the UE 110 receives PDCCH scrambled with C-RNTI to decode PDSCH containing the UE contention resolution identity MAC CE. In some embodiments, Msg. 4 may also include serving beam reconfiguration information for the UE 110.

In some embodiments, the UE 110 may further indicate to the gNB 120 that the early BFR procedure is performed/early BFR is indicated during or after the random access/early BFR procedure. For example, the indication may be transmitted in Msg. 3 or following uplink transmission. The early BFR information/indication may be provided in a MAC CE. MAC CE may carry an indication that the MAC CE is transmitted/generated due to the early BFR procedure. The MAC CE may provide information on early BFR on one or more serving cell/cells (such as PCell/SCell).

In some examples the early BFR information may be provided on any uplink message/or channel such as PUCCH/PUSCH/MAC CE/RRC.

In some embodiments, early beam failure recovery for SCell can be performed either 1) by random access to SpCell (PCell/PSCell) 2) by using an available uplink grant on SpCell or any SCell with uplink 3) or any means that can be used to transmit information to network. The early BFR information may be provided in a MAC CE. In some cases, UE may determine not to transmit early BFR information on uplink of a failed cell.

In some embodiments, the early BFR information/indication may be implicitly encoded in the uplink preamble such as SR/RA (scheduling request/random access) resource or any other preamble. As an example, the selection and transmission of specific CFRA preamble may inform the network that UE has determined the occurrence of early BFR, and indicate new downlink/uplink beam to network.

In some embodiments, the four-step CBRA-based BFR procedure may be implemented instead by two steps. The two-step procedure may combine Msg. 1 and Msg. 3 as a single Msg. A and combine Msg. 2 and Msg. 4 as a single Msg. B. Compared with the four-step procedure, the two-step procedure would reduce latency and signaling overhead.

Thus, such mechanisms may help the UE trigger the beam failure recovery (BFR) procedure much earlier. The UE can trigger the BFR procedure when at least one serving beam is in failure and a better beam than the failed serving beam is available, and it does not need to wait until all the serving beams are detected in failure for a maximum number of times. It greatly reduces the service outage time. Additionally, such techniques may allow the network to reconfigure serving beams for the UE in a more timely manner.

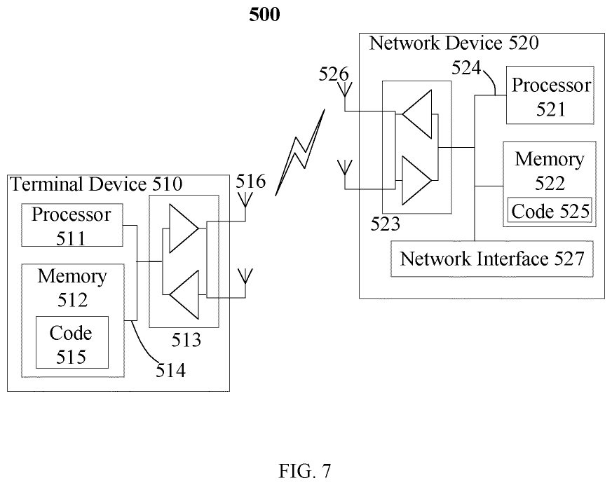

FIG. 7 is a block diagram illustrating a communication system 500 in which example embodiments of the present disclosure can be implemented. The communication system 500 may be a part of a communication network. As shown in FIG. 7, the communication system 500 may include a terminal device 510 which may be implemented as the UE 110 discussed above, a network device 520 which may be implemented as the base station (gNB) 120 discussed above.

Referring to FIG. 7, the terminal device 510 may comprise one or more processors 511, one or more memories 512 and one or more transceivers 513 interconnected through one or more buses 514. The one or more buses 514 may be address, data, or control buses, and may include any interconnection mechanism such as series of lines on a motherboard or integrated circuit, copper cables, optical fibers, or other electrical/optical communication equipment, and the like. Each of the one or more transceivers 513 may comprise a receiver and a transmitter, which are connected to a plurality of antennas 516. The plurality of antennas 516 may form an antenna array to perform beamforming communication with the network device 520. The one or more memories 512 may include computer program code 515. The one or more memories 512 and the computer program code 515 may be configured to, when executed by the one or more processors 511, cause the terminal device 510 to perform procedures and steps relating to the UE 110 as described above.

The network device 520 can be implemented as a single network node, or disaggregated/distributed over two or more network nodes, such as a central unit (CU), a distributed unit (DU), a remote radio head-end (RRH), using different functional-split architectures and different interfaces. The network device 520 may comprise one or more processors 521, one or more memories 522, one or more transceivers 523 and one or more network interfaces 527 interconnected through one or more buses 524. The one or more buses 524 may be address, data, or control buses, and may include any interconnection mechanism such as a series of lines on a motherboard or integrated circuit, copper cables, optical fibers, or other electrical/optical communication equipment, and the like. Each of the one or more transceivers 523 may comprise a receiver and a transmitter, which are connected to a plurality of antennas 526. The network device 520 may operate as a base station for the terminal device 510 and wirelessly communicate with the terminal device 510 through the plurality of antennas 526. The plurality of antennas 526 may form an antenna array to perform beamforming communication with the terminal device 510. The one or more network interfaces 527 may provide wired or wireless communication links through which the network device 520 may communicate with other network devices, entities or functions. The one or more memories 522 may include computer program code 525. The one or more memories 522 and the computer program code 525 may be configured to, when executed by the one or more processors 521, cause the network device 520 to perform procedures and steps relating to the base station (gNB) 120 as described above.

The one or more processors 511, 521 discussed above may be of any appropriate type that is suitable for the local technical network, and may include one or more of general purpose processors, special purpose processor, microprocessors, a digital signal processor (DSP), one or more processors in a processor based multi-core processor architecture, as well as dedicated processors such as those developed based on Field Programmable Gate Array (FPGA) and Application Specific Integrated Circuit (ASIC). The one or more processors 511, 521 may be configured to control other elements of the UE/network device and operate in cooperation with them to implement the procedures discussed above.

The one or more memories 512, 522 may include at least one storage medium in various forms, such as a volatile memory and/or a non-volatile memory. The volatile memory may include but not limited to for example a random access memory (RAM) or a cache. The non-volatile memory may include but not limited to for example a read only memory (ROM), a hard disk, a flash memory, and the like. Further, the one or more memories 512, 522 may include but not limited to an electric, a magnetic, an optical, an electromagnetic, an infrared, or a semiconductor system, apparatus, or device or any combination of the above.

It would be understood that blocks in the drawings may be implemented in various manners, including software, hardware, firmware, or any combination thereof. In some example embodiments, one or more blocks may be implemented using software and/or firmware, for example, machine-executable instructions stored in the storage medium. In addition to or instead of machine-executable instructions, parts or all of the blocks in the drawings may be implemented, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-Chip systems (SOCs), Complex Programmable Logic Devices (CPLDs), etc.

Some example embodiments further provide computer program code or instructions which, when executed by one or more processors, may cause a device or apparatus to perform the procedures described above. The computer program code for carrying out procedures of the example embodiments may be written in any combination of one or more programming languages. The computer program code may be provided to one or more processors or controllers of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

Some example embodiments further provide a computer program product or a computer readable medium having the computer program code or instructions stored therein. The computer readable medium may be any tangible medium that may contain, or store a program for use by or in connection with an instruction execution system, apparatus, or device. The machine readable medium may be a machine readable signal medium or a machine readable storage medium. A machine readable medium may include but is not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular example embodiments. Certain features that are described in the context of separate example embodiments may also be implemented in combination in a single example embodiment. Conversely, various features that are described in the context of a single example embodiment may also be implemented in multiple example embodiments separately or in any suitable sub-combination.

Although the subject matter has been described in a language that is specific to structural features and/or method actions, it is to be understood the subject matter defined in the appended claims is not limited to the specific features or actions described above. On the contrary, the above-described specific features and actions are disclosed as an example of implementing the claims.

1. A terminal device comprising:
at least one processor; and
at least one memory including computer program code, the at least one memory and the computer program code configured to, with the at least one processor, cause the terminal device to:
detect a beam failure state in association with at least one serving beam;
determine if at least one non-serving beam better than the at least one serving beam is available; and
trigger an early beam failure recovery (BFR) procedure in a case where the beam failure state is detected and the at least one non-serving beam better than the at least one serving beam is available.

2. The terminal device of claim 1 wherein the at least one serving beam carries a downlink control channel.

3. The terminal device of claim 1 wherein the beam failure state is detected when at least one of following conditions is satisfied:
a number Y of beam failure instances (BFIs) are detected where the number Y is an integer larger than or equal to one; and
at least one beam failure detection reference signal (BFD-RS) has a quality lower than a threshold.

4-5. (canceled)

6. The terminal device of claim 1 wherein the at least one non-serving beam is determined to be better than the at least one serving beam when at least one of following conditions is satisfied:
the at least one non-serving beam has a quality better than the at least one serving beam by an offset Off for a time period TTT;
the at least one non-serving beam is included in at least one beam measurement report sent from the terminal device to network and has a quality better than the at least one serving beam; and
the at least one non-serving beam is included as a highest quality beam in at least one beam measurement report sent from the terminal device to network.

7. The terminal device of claim 1 wherein the at least one memory and the computer program code are further configured to, with the at least one processor, cause the terminal device to:
start a timer T when the beam failure state is detected and the at least one non-serving beam is determined to be better than the at least one serving beam,
wherein the early BFR procedure is triggered when the timer T expires.

8. The terminal device of claim 7 wherein the at least one memory and the computer program code are further configured to, with the at least one processor, cause the terminal device to:
stop the timer T in response to one or more of:
a beam switching command received from network;
a cell change command received from the network; and
a radio resource control (RRC) level measurement reporting event A3 triggered at the terminal device.

9-10. (canceled)

11. The terminal device of claim 1 wherein the at least one memory and the computer program code are further configured to, with the at least one processor, cause the terminal device to:
indicate information of the at least one serving beam to network during the early BFR procedure.

12. The terminal device of claim 1 wherein the at least one memory and the computer program code are further configured to, with the at least one processor, cause the terminal device to:
provide an indication that the early BFR procedure is performed to network during or after the early BFR procedure.

13. The terminal device of claim 1 wherein the at least one memory and the computer program code are further configured to, with the at least one processor, cause the terminal device to:
report capability of the terminal device to network, the capability of the terminal device including an indicator indicating that the terminal device supports the early BFR procedure; and
receive configuration for the early BFR procedure from the network.

14. (canceled)

15. A network device comprising:
at least one processor; and
at least one memory including computer program code, the at least one memory and the computer program code configured to, with the at least one processor, cause the network device to:
receive a capability report from a terminal device, the capability report including an indicator indicating that the terminal device supports an early beam failure recovery (BFR) procedure; and
send configuration for the early BFR procedure to the terminal device.

16. The network device of claim 15 wherein the configuration for the early BFR procedure comprises one or more of:
a number Y of beam failure instance (BFIs) to trigger the early BFR procedure;
an offset Off, a time to trigger TTT, and one or more filtering parameters for beam measurement and comparison; and
a time duration Z for a timer.

17. (canceled)

18. The network device of claim 15 wherein the at least one memory and the computer program code are further configured to, with the at least one processor, cause the network device to:
receive from the terminal device information of at least one serving beam in a beam failure state during an early BFR procedure; and
re-configure at least one beam in replacement of the at least one failed serving beam for the terminal device.

19. The network device of claim 15 wherein the at least one memory and the computer program code are further configured to, with the at least one processor, cause the network device to:
receive from the terminal device an indication that the early BFR procedure is performed during or after the early BFR procedure.

20. A method implemented at a terminal device comprising:
detecting a beam failure state in association with at least one serving beam;
determining if at least one non-serving beam better than the at least one serving beam is available; and
triggering an early beam failure recovery (BFR) procedure in a case where the beam failure state is detected and the at least one non-serving beam better than the at least one serving beam is available.

21. The method of claim 20 wherein the beam failure state is detected when at least one of following conditions is satisfied:
a number Y of beam failure instances (BFIs) are detected where the number Y is an integer larger than or equal to one; and
at least one beam failure detection reference signal (BFD-RS) has a quality lower than a threshold.

22. The method of claim 20 wherein the at least one non-serving beam is determined to be better than the at least one serving beam when at least one of following conditions is satisfied:
the at least one non-serving beam has a quality better than the at least one serving beam by an offset Off for a time period TTT;
the at least one non-serving beam is included in at least one beam measurement report sent from the terminal device to network and has a quality better than the at least one serving beam; and
the at least one non-serving beam is included as a highest quality beam in at least one beam measurement report sent from the terminal device to network.

23. The method of claim 20 further comprising:
starting a timer T when the beam failure state is detected and the at least one non-serving beam is determined to be better than the at least one serving beam,
wherein the early BFR procedure is triggered when the timer T expires.

24-26. (canceled)

27. The method of claim 20 further comprising:
indicating information of the at least one serving beam to network during the early BFR procedure.

28. The method of claim 20 further comprising:
providing an indication that the early BFR procedure is performed to network during or after the early BFR procedure.

29. The method of claim 20 further comprising:
reporting capability of the terminal device to network, the capability of the terminal device including an indicator indicating that the terminal device supports the early BFR procedure; and
receiving configuration for the early BFR procedure from the network.

30-39. (canceled)
